(19) United States
(12) Patent Application Publication
(10) Pub. No.: US 2016/0052688 A1
(43) Pub. Date: Feb. 25, 2016

(54) INTERIOR AND EXTERIOR PIPE END COVER

(71) Applicant: DRADER MANUFACTURING INDUSTRIES LTD., Edmonton (CA)

(72) Inventors: Abiy WUBNEH, Edmonton (CA); Jeffrey MCTAVISH, Edmonton (CA)

(21) Appl. No.: 14/466,641

(22) Filed: Aug. 22, 2014

(51) Int. Cl. B65D 59/06; F16L 57/00

(52) U.S. Cl. CPC B65D 59/06; F16L 57/005

(57) ABSTRACT

A cover for an end of a pipe has a cover body having an inner cavity that is open at a first end, an end wall that closes the cavity at a second end, and a pipe engaging sidewall between the first end and the second end. The pipe engaging sidewall has an inner surface and an outer surface that are sized to engage the outer and inner diameters, respectfully, of the male and female connections of the pipe. The pipe engaging sidewall has one or more inner ribs that extend inward into the inner cavity from the inner surface that are collapsible toward the inner surface and one or more outer ribs that extend outward from the outer surface relative to the inner cavity that are collapsible toward the outer surface.

### TECHNICAL FIELD

This relates to a cover for the ends of pipe, such as plastic pipe, that may be used when transporting or storing the pipes.

### BACKGROUND

In order to protect tubular bodies such as pipes during handling, transportation, and storage, the ends of pipe sections are frequently covered. This prevents contaminants such as dust or rodents from entering the pipe sections. One example of a protective cover for a pipe end is found in U.S. Pat. No. 5,337,792.

### SUMMARY

According to an aspect, there is provided a cover for an end of a pipe, the pipe comprising a male connection having an outer diameter at a first end of the pipe and a female connection having an inner diameter at a second end of the pipe, the inner diameter of the female connection being substantially the same as the outer diameter of the male connection, the cover comprising a cover body comprising an inner cavity that is open at a first end, an end wall that closes the cavity at a second end, and a pipe engaging sidewall between the first end and the second end. The pipe engaging sidewall comprises an inner surface sized to engage the outer diameter of the male connection of the pipe, an outer surface sized to engage the inner diameter of the female connection of the pipe, inner ribs that extend inward into the inner cavity from the inner surface that are collapsible toward the inner surface and one or more outer ribs that extend outward from the outer surface relative to the inner cavity that are collapsible toward the outer surface.

According to another aspect, the inner ribs may be spaced along the pipe engaging sidewall relative to the outer ribs.

According to another aspect, the one or more inner and outer ribs may be segmented along a circumference of the pipe engaging sidewall.

According to another aspect, the one or more inner and outer ribs may comprise four or more segments spaced along the circumference of the pipe engaging sidewall.

According to another aspect, the cover may be formed from plastic that is vacuum molded or injection molded.

According to an aspect, there is provided, in combination, a pipe comprising a male connection having an outer diameter at a first end of the pipe and a female connection having an inner diameter at a second end of the pipe, the inner diameter of the female connection being substantially the same as the outer diameter of the male connection, and one or more covers as described above.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a cover for an end of a pipe.

FIG. 2 is a side elevation view of the cover shown in FIG. 1.

FIG. 3 is a perspective view of a pipe with covers on both ends.

FIG. 4 is a perspective view of an end of a pipe connected to another end of a pipe.

FIG. 5 is a side elevation view in section of an end of a pipe connected to another end of a pipe as in FIG. 4.

FIG. 6 is a perspective view of a cover for an end of a pipe mounted to a female connection of a pipe.

FIG. 7 is a perspective view of a cover for an end of a pipe mounted to a male connection of a pipe.

FIG. 8 is a side elevation view in section if a pipe with covers mounted to both ends.

FIG. 9 is a side elevation view in section of a cover for an end of a pipe mounted to a female connection of a pipe.

FIG. 10 is a side elevation view in section of a cover for an end of a pipe mounted to a male connection of a pipe.

FIG. 11 is a detailed side elevation view in section of a cover for an end of a pipe mounted to a female connection of a pipe.

FIG. 12 is a detailed side elevation view in section of a cover for an end of a pipe mounted to a male connection of a pipe.

FIG. 13 is a perspective view of a pipe with covers on both ends with a detached flange.

### DETAILED DESCRIPTION

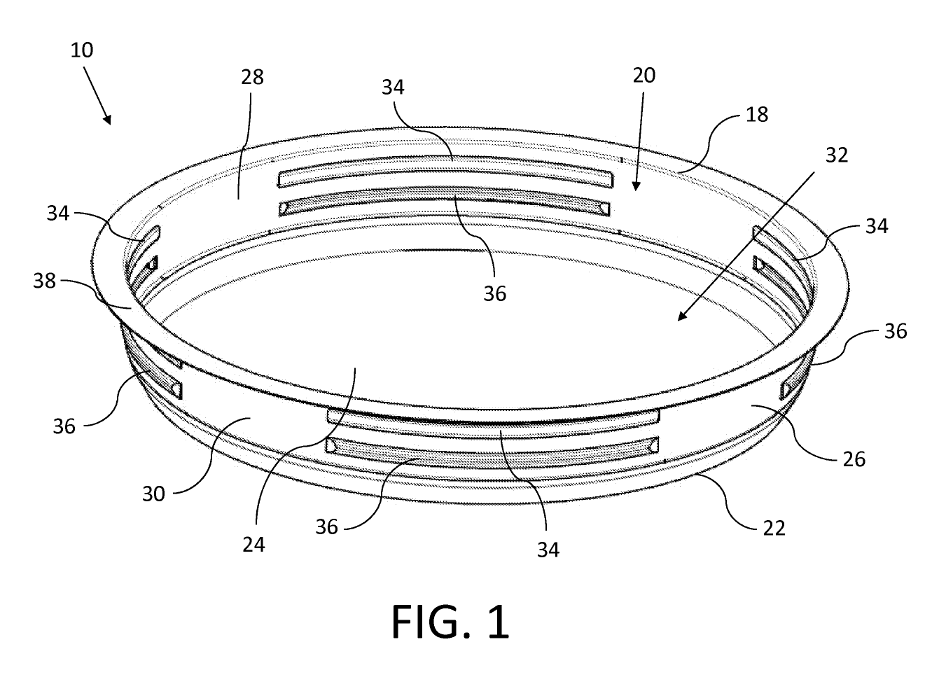

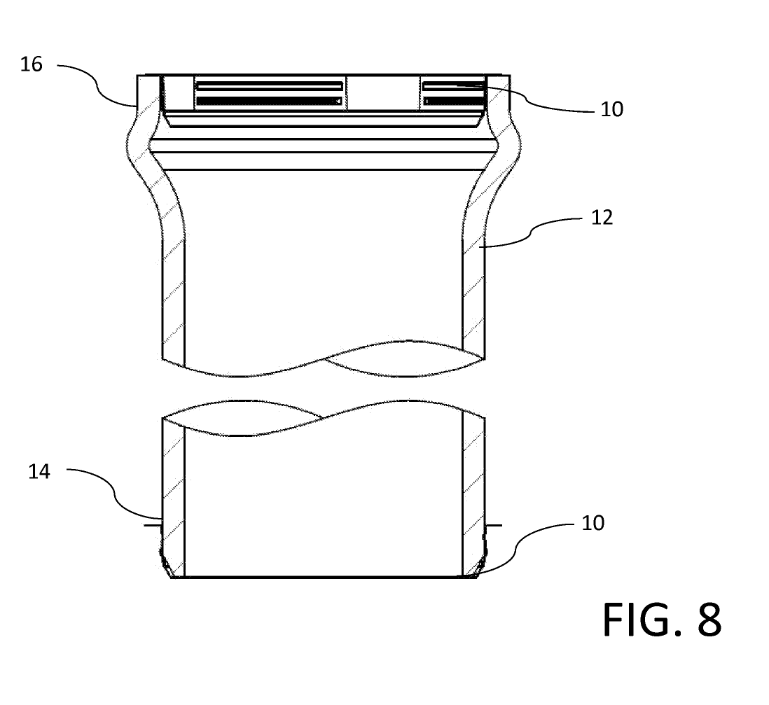

A cover for an end of a pipe, generally identified by reference numeral 10, will now be described with reference to FIG. 1 through 13.

Structure of Parts

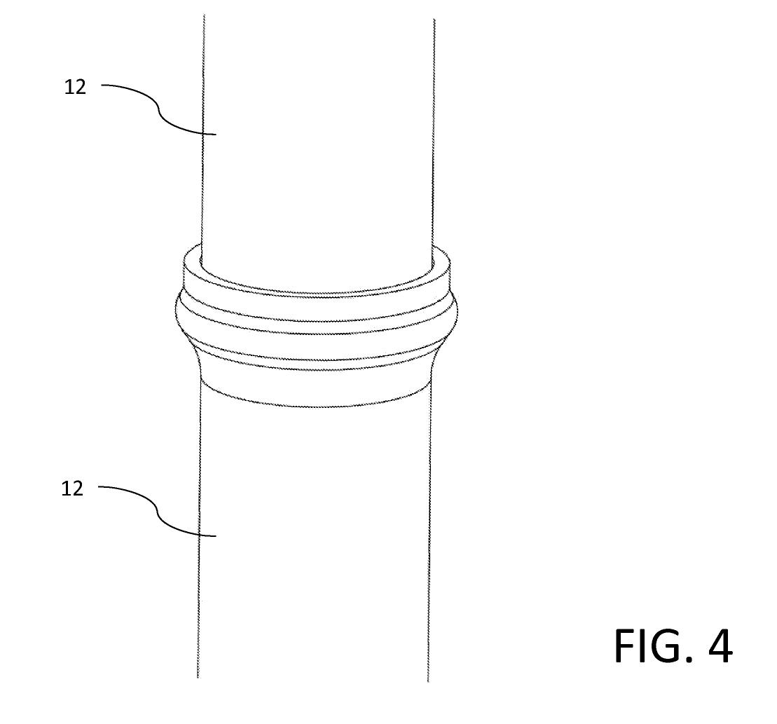

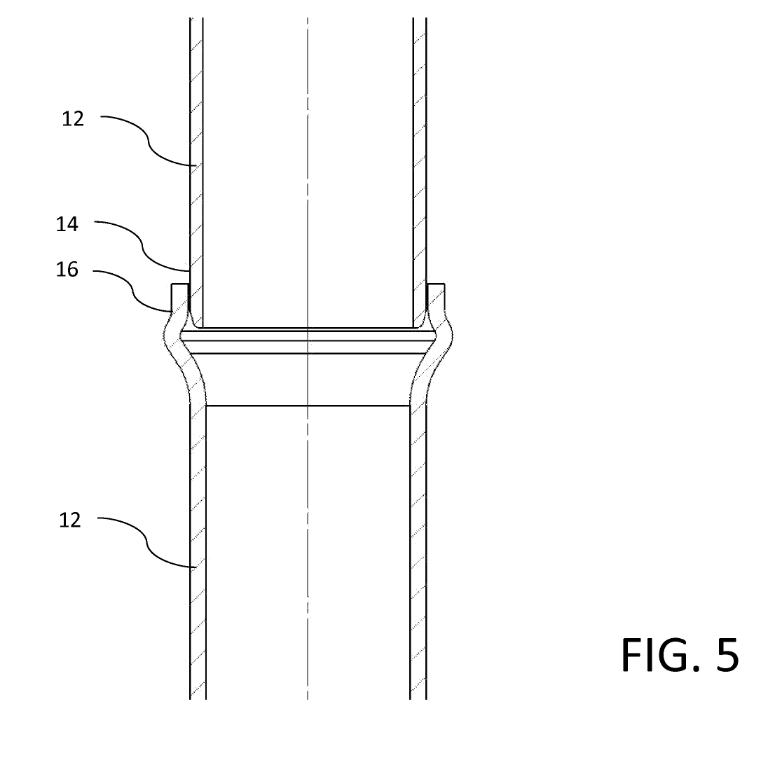

Referring to FIGS. 4 and 5, sections of pipe 12 are connected together in order to form longer pipes. As is well known in the art, shorter pipe sections 12 are more practical for shipping and transportation. In the depicted example pipe sections 12 are not threaded, however, it will be understood that various types of attachments, including threaded and non-threaded connections may be used for pipes in the industry. Sections of pipe 12 will be referred to as pipe 12 for convenience, although it will be understood that these sections are used to assemble a longer pipe. Pipe 12 has a male connection 14 at a first end of pipe 12 and a female connection 16 at a second end of pipe 12. Male connection 14 is sized to fit within female connection 16 with the inner diameter of female connection 16 substantially the same as the outer diameter of the male connection 14. Various methods of assembling pipes 12 are known in the industry and will not be discussed further. Generally, pipes 12 are designed to connect in a friction-fit arrangement

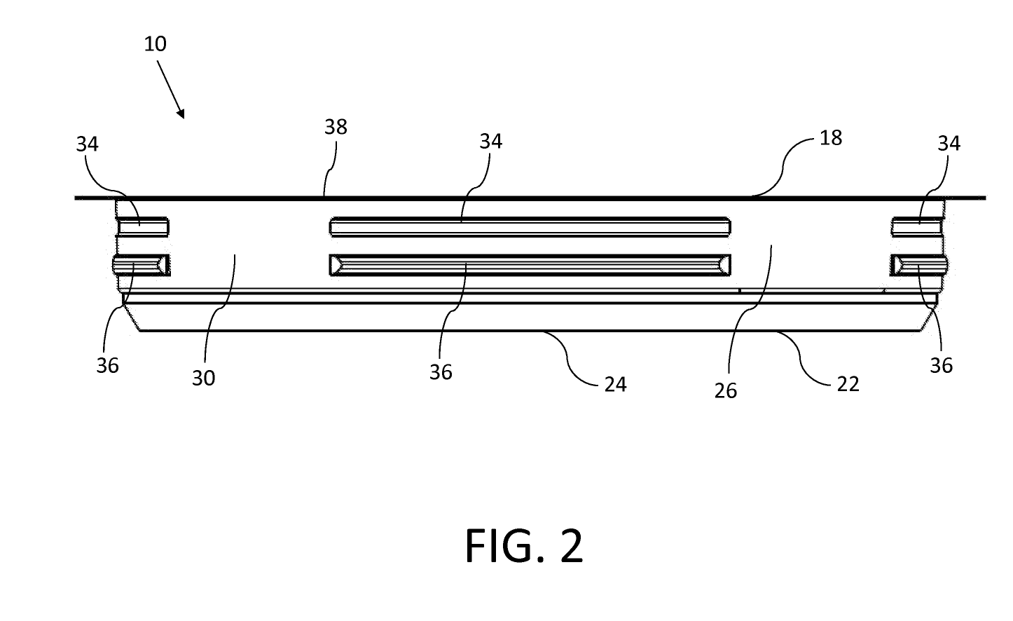

Referring to FIG. 1 and FIG. 2, cover 10 has a first end 18 with an opening 20 and a second end 22 opposite first end 18 with an end wall 24. Extending between first end 18 and second end 22 is pipe engaging sidewall 26 having inner surface 28 and outer surface 30. Inner surface 28 and end wall 24 define inner cavity 32. Inner surface 28 is sized to engage the outer diameter of male connection 14, and outer surface 30 is sized to engage the inner diameter of female connection 16. Pipe engaging sidewall 26 has one or more inner ribs 34 that extend inward into inner cavity 32 from inner surface 28. Inner ribs 34 are collapsible toward inner surface 28. Pipe engaging sidewall 26 also has one or more outer ribs 36 that extend outward from outer surface 30 relative to inner cavity 32. Outer ribs 36 are collapsible toward outer surface 30. In a preferred embodiment, inner ribs 34 are spaced along pipe engaging sidewall 26 relative to outer ribs 36. As shown in FIG. 1 pipe engaging sidewall 26 has four inner ribs 34 and four outer ribs 36, each spaced circumferentially around sidewall 26. Each set of ribs 34 or 36 may also be considered one rib segmented into four sections. It will be understood that pipe engaging sidewall 26 may have any number of ribs or sets of ribs, depending on the size of cover 10 and the requirements of the application. More preferably, inner and outer ribs 34 and 36 are separated into four or more segments spaced along the circumference of pipe engaging sidewall 26 as discussed above. The segmentation of ribs 34 and 36 along the circumference of pipe engaging sidewall 26 allows for crushing or stretching of cover 10 in use. Cover 10 is preferably formed from plastic that is vacuum molded or injection molded, although it will be understood that other materials and molding methods may be used. Preferably, cover 10 be made of semi-rigid material that is flexible enough to allow cover 10 to be stretched or crushed, and has sufficient resilience to apply an inward or outward force to pipe 12, as the case may be.

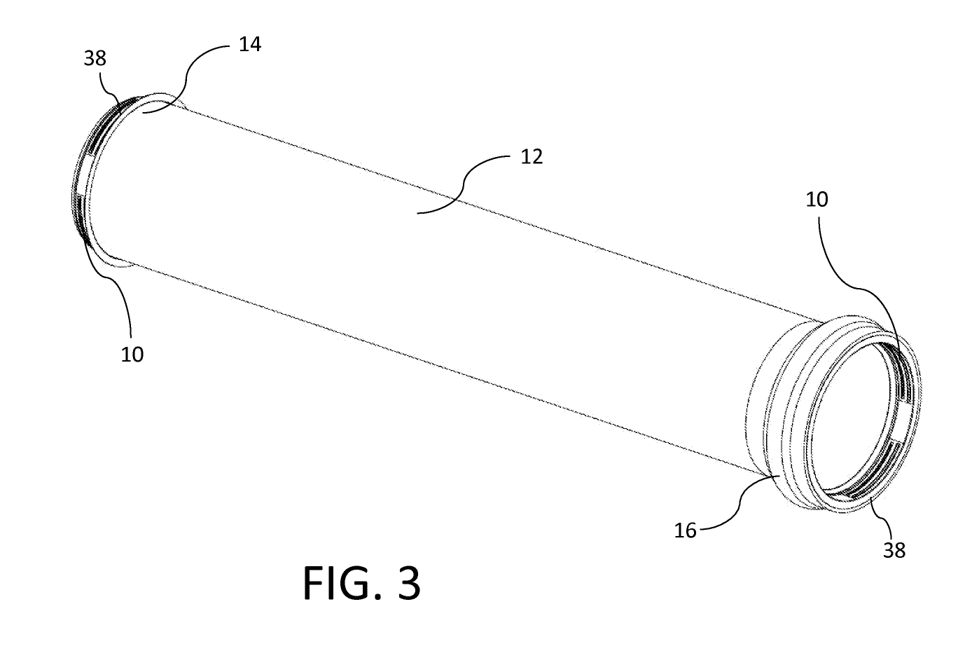

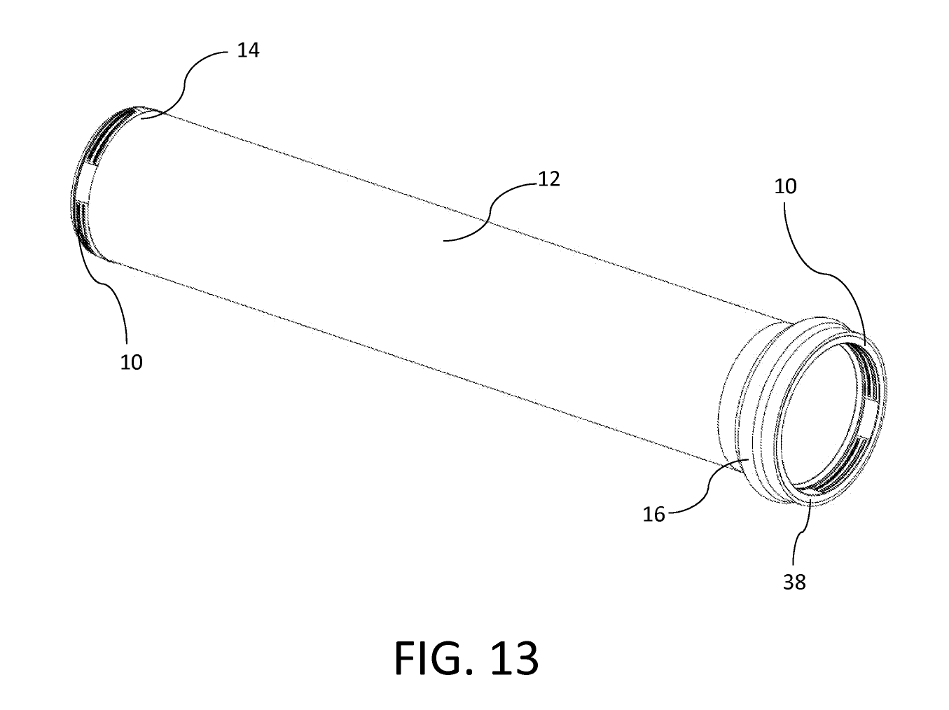

As shown, cover 10 has an end flange 38 opposite end wall 24. Referring to FIG. 3, when inserted into female connection 16, this helps properly position cover 10 within pipe 12. However when inserted over male connection 14, flange 38 may become an obstruction and in some cases, may result in cover 10 being unintentionally removed. In a preferred embodiment, flange 38 may be detachable, such as by providing a perforated line between flange 38 and sidewall 26, or at a convenient point on sidewall 26, which allows flange 38 to be removed, as shown in FIG. 13.

Operation

Referring to FIG. 5, pipe 12 has a female end and a male end. While this is the most common type of pipe, it will be understood that other types of pipe or connectors may have two female ends, or two male ends, and the covers that are described herein may be used on these pipes as well.

As shown in FIGS. 4 and 5, pipe 12 is designed to be connected end to end with other pipes, such that male and female ends are substantially the same size, or are designed and sized within tolerances that allows pipe 12 to be connected, preferably by friction-fit. Generally, pipes 12 are connected together using an adhesive or welding technique to enhance the friction fit. Cover 10 described herein is designed to engage both the inner and outer diameters of both ends of pipe 12. As shown in FIG. 3, cover 10 is sized to fit over the exterior of male connection 14, and within the interior of female connection 16.

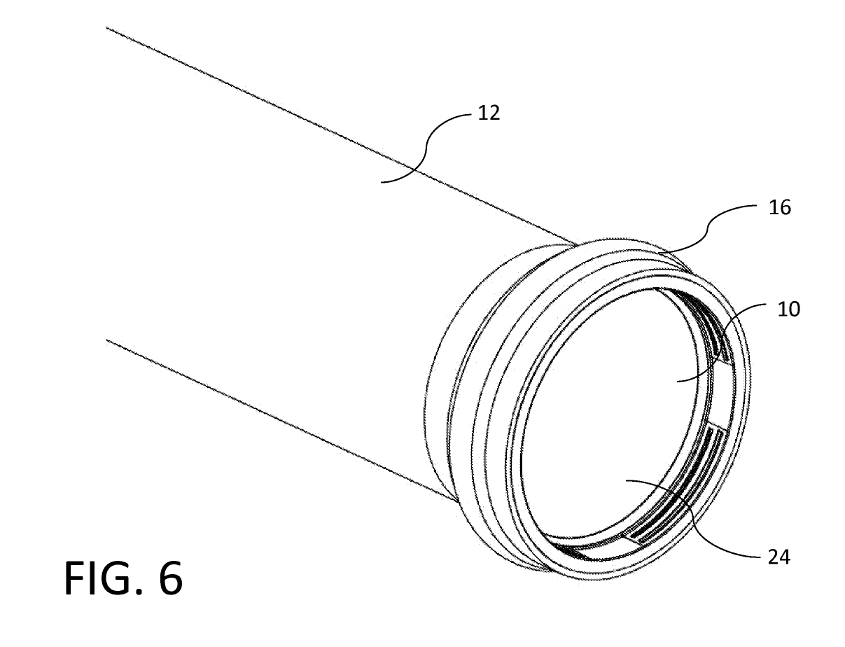

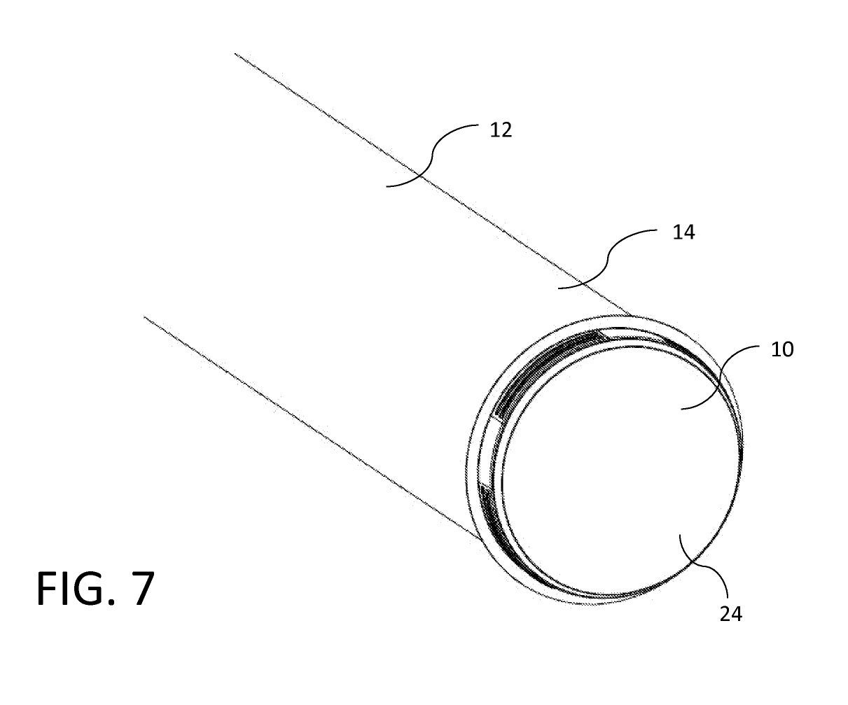

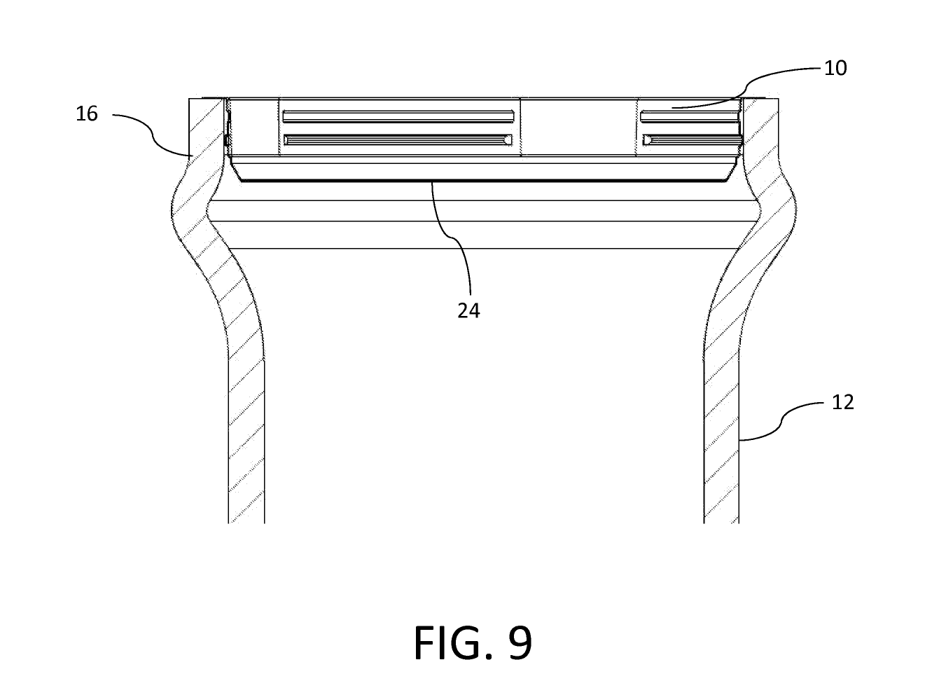

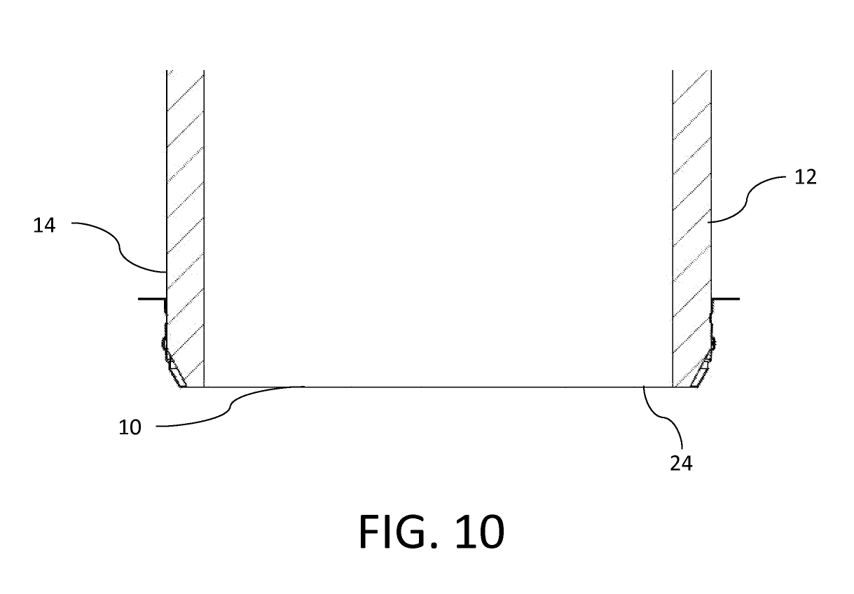

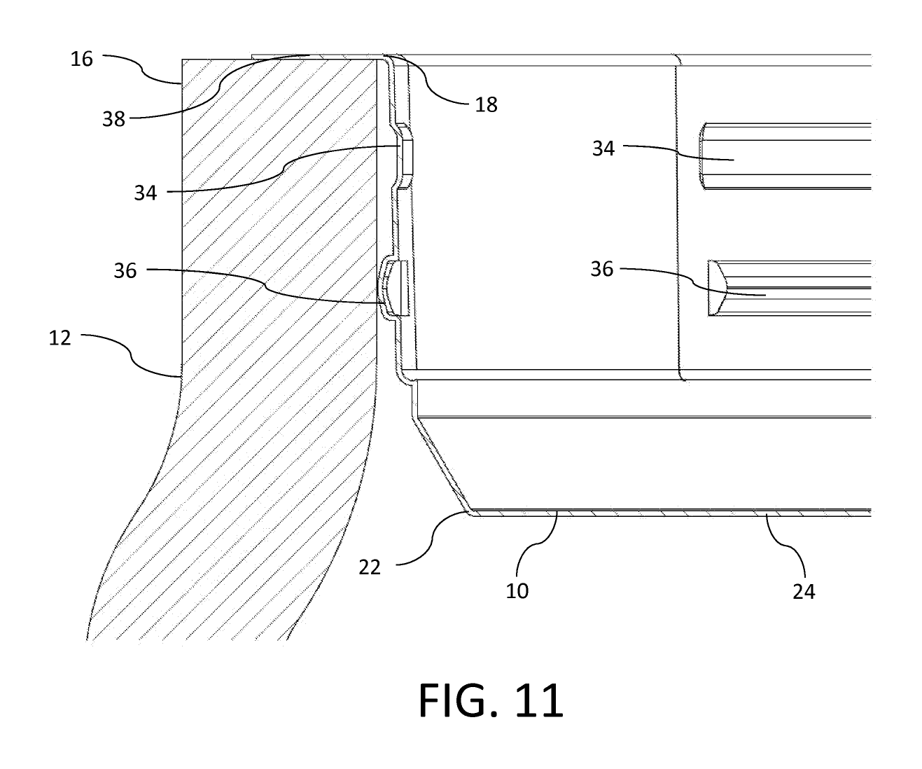

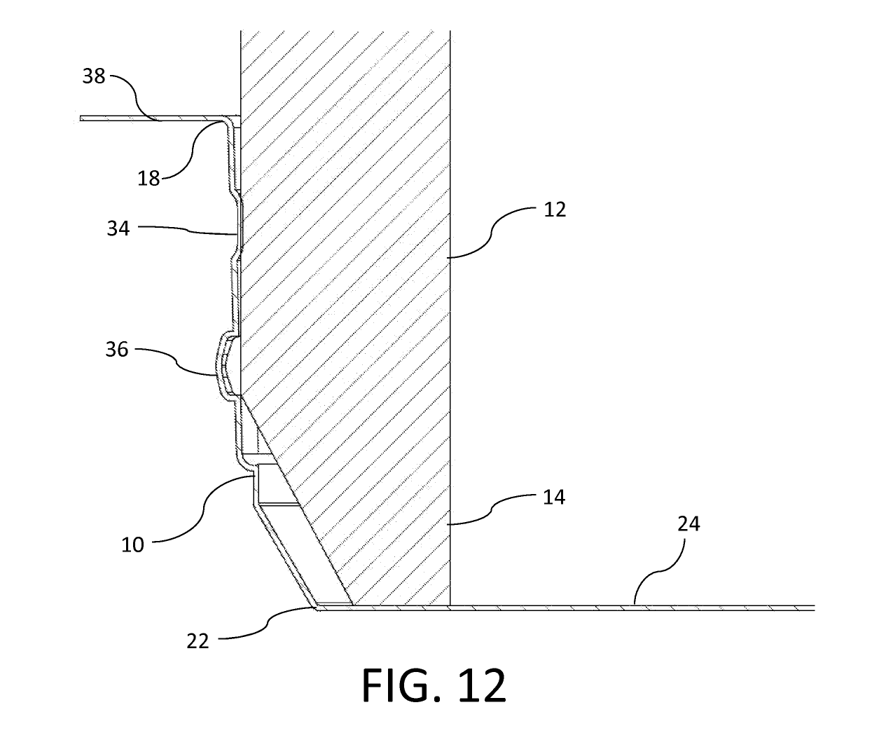

Referring to FIG. 7 and FIG. 10, when cover 10 is applied to male connection 14 of pipe 12 it will be forced to stretch over the pipe 12 and the inner ribs 34 will engage with the exterior of pipe 12. Preferably, cover 10 is made from a resilient material that applies an inward force against male connection 14. However, since cover 10 is closed at one end and open at the other, the inward force is not orthogonal to the surface, such that the force would be toward disengaging cover 10 from pipe 12. Inner ribs 34 increase the friction force such that cover 10 will remain on male connection 14 instead of being forced off by the pressure applied by the stretching force. As inner ribs 34 are designed to be crushed, and are segmented along the circumference of cover 10, inner ribs 34 are able to provide a more orthogonal force against male connection 14. FIG. 12 shows a detailed view of inner ribs 34 engaging male connection 14 when cover 10 is stretched over male connection 14. Referring to FIG. 6 and FIG. 9, when cover 10 is applied to female connection 16 of pipe 12, the resilience of cover 10 will push outward against female connection 16. Outer ribs 36 may crush as they enter pipe 12 and engage with the interior of pipe 12. FIG. 11 shows a detailed view of outer ribs 36 engaging female connection 16 when cover 10 is crushed to fit within female connection 16. It is preferable that the inner and outer ribs 34 and 36 are segmented along the circumference of pipe engaging sidewall 26, as this allows for a greater ability to deform along pipe engaging sidewall 26 while allowing inner and outer ribs 34 and 36 to apply pressure against the outside of male connection 14 and the inside of female connection 16 respectively.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

What is claimed is:

1. A cover for an end of a pipe, the pipe comprising a male connection at a first end of the pipe and a female connection at a second end of the pipe, the male connection having an outer diameter and the female connection having an inner diameter at a second end of the pipe, the inner diameter of the female connection being substantially the same as the outer diameter of the male connection, the cover comprising:
a cover body comprising an inner cavity that is open at a first end, an end wall that closes the cavity at a second end, and a pipe engaging sidewall between the first end and the second end;
the pipe engaging sidewall comprising:
an inner surface sized to engage the outer diameter of the male connection of the pipe;
an outer surface sized to engage the inner diameter of the female connection of the pipe;
one or more inner ribs that extend inward into the inner cavity from the inner surface, the inner ribs being collapsible toward the inner surface; and
one or more outer ribs that extend outward from the outer surface relative to the inner cavity, the outer ribs being collapsible toward the outer surface.

2. The cover of claim 1, wherein the inner ribs are spaced along the pipe engaging sidewall relative to the outer ribs.

3. The cover of claim 1, wherein the one or more inner and outer ribs are segmented along a circumference of the pipe engaging sidewall.

4. The cover of claim 3, wherein the one or more inner and outer ribs comprise four or more segments spaced along the circumference of the pipe engaging sidewall.

5. The cover of claim 1, wherein the cover is formed from plastic that is vacuum molded or injection molded.

6. In combination:
a pipe comprising:
a male connection having an outer diameter at a first end of the pipe and a female connection having an inner diameter at a second end of the pipe, the inner diameter of the female connection being substantially the same as the outer diameter of the male connection,
one or more covers for at least one end of the pipe, the cover comprising:
a cover body comprising an inner cavity that is open at a first end and closed at a second end, the cover body further comprising a sidewall between the first end and the second end, the sidewall comprising a pipe engaging sidewall;
the pipe engaging sidewall comprising:
an inner surface sized to engage the outer diameter of the male connection of the pipe;
an outer surface sized to engage the inner diameter of the female connection of the pipe;
one or more inner ribs that extend inward into the inner cavity from the inner surface, the inner ribs being collapsible toward the inner surface; and
one or more outer ribs that extend outward from the outer surface relative to the inner cavity, the outer ribs being collapsible toward the outer surface.

7. The combination of claim 6, wherein the inner ribs of the cover are spaced along the pipe engaging sidewall relative to the outer ribs.

8. The combination of claim 6, wherein the one or more inner and outer ribs of the cover are segmented along a circumference of the pipe engaging sidewall.

9. The combination of claim 8, wherein the one or more inner and outer ribs of the cover comprise four or more segments spaced along the circumference of the pipe engaging sidewall.

10. The combination of claim 6, wherein the cover is formed from plastic that is vacuum molded or injection molded.
